(19) United States
(12) Patent Application Publication
(10) Pub. No.: US 2018/0004840 A1
(43) Pub. Date: Jan. 4, 2018

(54) INTERACTIVE MOBILE MULTIMEDIA SERVICE KIOSK

(71) Applicant: Mario L. Herbelin, San Diego, CA (US)

(72) Inventor: Mario L. Herbelin, San Diego, CA (US)

(21) Appl. No.: 15/636,620

(22) Filed: Jun. 28, 2017

Related U.S. Application Data
(60) Provisional application No. 62/356,473, filed on Jun. 29, 2016.

(51) Int. Cl. G06F 17/30; G06F 3/16; H04L 29/06; G06T 7/80; G06K 9/00

(52) U.S. Cl. CPC G06F 17/30781; H04L 65/602; G06T 7/80; G06F 3/162; G06K 9/00228

(57) ABSTRACT

A multimedia kiosk includes: at least one power storage element; a media player; and at least one multimedia presentation element. A mobile interactive service podium includes: a frame; a set of displays coupled to the frame; a desktop coupled to the frame; a storage cabinet coupled to the frame; and a wireless communication module coupled to the frame. A method of providing multimedia content via a mobile kiosk includes: retrieving multimedia content from a storage; rendering the multimedia content at a media player; and providing the rendered content to at least one display.

### CROSS-REFERENCE TO RELATED APPLICATIONS

This application claims priority to U.S. Provisional Patent Application Ser. No. 62/356,473, filed on Jun. 29, 2016.

### BACKGROUND

Many service providers may use podiums, stands, carts, etc. to help provide services to clients or customers. Existing solutions may include static labelling or signage that is limited in scope and target audience. In addition, existing solutions do not allow users to interact with the service via such a mobile resource.

Therefor there exists a need for a mobile kiosk able to provide interactive and updateable multimedia to a group of viewers.

### SUMMARY

Some embodiments provide a mobile service kiosk (or “console”, “stand”, “podium”, “cart”, etc.). Such a mobile service kiosk may include structural support elements that together provide a frame. The frame may include a number of support features that are able to house and support one or more multimedia displays. Such displays may be used to provide advertising content in some embodiments, where such content may be provided through a resource such as an out of home (OOH) network.

In a typical arrangement, a service podium may include a service side utilized by an administrative user or service provider. Such a service side may include, for instance a desktop or other workspaces, storage cabinets, drawers or lockers, and/or other features applicable for the service type (e.g., some embodiments may include key racks for use by valet services).

In addition to the service side, the kiosk may include multiple exterior faces. For example, in some embodiments, the kiosk may have a rectangular shape when viewed from above and include one service side and three exterior faces. Other embodiments may omit the service side and include four exterior faces.

Each exterior face may include one or more displays. The displays may be able to present multimedia content such as image data, graphics, video, etc. In addition, one or more exterior faces may include audio output elements such as speakers. Some embodiments may include media players that are able to render stored media and/or render streaming media for presentation by the displays and/or audio output elements.

The kiosk may include local power sources and/or power storage elements such that the kiosk may be moved during use and doesn't require a power connection nearby.

Some embodiments may include various control features and/or other user interface (UI) elements that may allow an administrative user to control the operations of the kiosk. Such UI elements may include, for instance, touchscreens, buttons, keypads, etc. that may be embedded into the desktop or other workspaces. Such UI elements may be used to at least partly control the selection and/or presentation of multimedia content.

In addition, in some embodiments, the UI elements may allow an administrator user to utilize the kiosk for provision of services. For instance, a valet user may be able to identify a key location (and/or vehicle location) based on an assigned ticket number entered using the UI elements. As another example, a hostess user may be able to view a wait list or reservation list, add customers to the list, send pages or texts to the customers, etc. In some embodiments, the UI elements may include public address elements (e.g., a microphone, amplifier, speakers, etc.) that may allow a user to address one or more customers.

The kiosk may include various communication features in some embodiments. Such features may include, for instance, radio transceivers, cellular communication modules, wireless communication modules, etc. In addition, some embodiments may be able to connect to one or more networks including the Internet such that cloud-based services may be provided. Furthermore, such features may allow some embodiments to provide network connectivity to one or more user devices.

Some embodiments may download new content (and/or otherwise update content) using the communication features. Administrative users may thus be able to update content among one or more kiosks from a remote location.

In some embodiments, the kiosk may transmit a beacon or other signal that is able to be received by various user devices. Responses received from such devices may be used to determine a number of viewers or customers in proximity to the kiosk, update content based on user demographics, etc.

The storage areas (and/or other areas) of some embodiments may be able to provide charging to various user devices.

Some embodiments may include cameras, sensors, etc. that may provide various security and/or surveillance features.

Some embodiments may include various food service or preparation elements. For instance, some embodiments may include refrigerators, cooktops, espresso machines, beer taps, etc.

The preceding Summary is intended to serve as a brief introduction to various features of some exemplary embodiments. Other embodiments may be implemented in other specific forms without departing from the scope of the disclosure.

### BRIEF DESCRIPTION OF THE SEVERAL VIEWS OF THE DRAWINGS

The exemplary features of the disclosure are set forth in the appended claims. However, for purpose of explanation, several embodiments are illustrated in the following drawings.

FIG. 1 illustrates a perspective view of a multimedia kiosk according to an exemplary embodiment;

FIG. 2 illustrates a side view of the multimedia kiosk of FIG. 1;

FIG. 3 illustrates a front view of the multimedia kiosk of FIG. 1;

FIG. 4 illustrates a top view of the multimedia kiosk of FIG. 1;

FIG. 5 illustrates a side view of the multimedia kiosk of FIG. 1;

FIG. 6 illustrates a side view of the multimedia kiosk of FIG. 1;

FIG. 7 illustrates a rear view of the multimedia kiosk of FIG. 1;

FIG. 8 illustrates a rear view of an alternative multimedia kiosk of some embodiments;

FIG. 9 illustrates a schematic block diagram of a hardware architecture of a multimedia kiosk according to an exemplary embodiment;

FIG. 10 illustrates a schematic block diagram of a system including a multimedia kiosk of some embodiments;

FIG. 11 illustrates a flow chart of an exemplary process that provides content via a multimedia kiosk of some embodiments;

FIG. 12 illustrates a flow chart of an exemplary process that identifies proximate user devices and updates operation of a multimedia kiosk of some embodiments based on the identified devices;

FIG. 13 illustrates a flow chart of an exemplary process that provides surveillance via a multimedia kiosk of some embodiments; and

FIG. 14 illustrates a schematic block diagram of an exemplary computer system used to implement some embodiments.

### DETAILED DESCRIPTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various features are described below that can each be used independently of one another or in combination with other features. Broadly, some embodiments generally provide a kiosk with multimedia presentation capabilities.

Such a kiosk (or “console”, or “podium”) may be appropriate for various applications, such as valet parking, restaurant greeting stations, hospitals, airports, schools, churches, auto dealerships, customs, trade shows, etc. The kiosk may be portable and may include various multimedia presentation elements (e.g., displays, speakers, etc.). Some embodiments may provide wireless communication such that the kiosk may be able to be controlled remotely and/or otherwise wirelessly communicate with other devices.

A first exemplary embodiment provides a multimedia kiosk comprising: at least one power storage element; a media player; and at least one multimedia presentation element.

A second exemplary embodiment provides a mobile interactive service podium comprising: a frame; a set of displays coupled to the frame; a desktop coupled to the frame; a storage cabinet coupled to the frame; and a wireless communication module coupled to the frame.

A third exemplary embodiment provides a method of providing multimedia content via a mobile kiosk, the method comprising: retrieving multimedia content from a storage; rendering the multimedia content at a media player; and providing the rendered content to at least one display.

Several more detailed embodiments are described in the sections below. Section I provides a description of various structural architectures of some embodiments. Section II then describes hardware architectures of some embodiments. Next, Section III describes exemplary methods of operation used by some embodiments. Lastly, Section IV describes a computer system which implements some of the embodiments.

### Structural Architecture

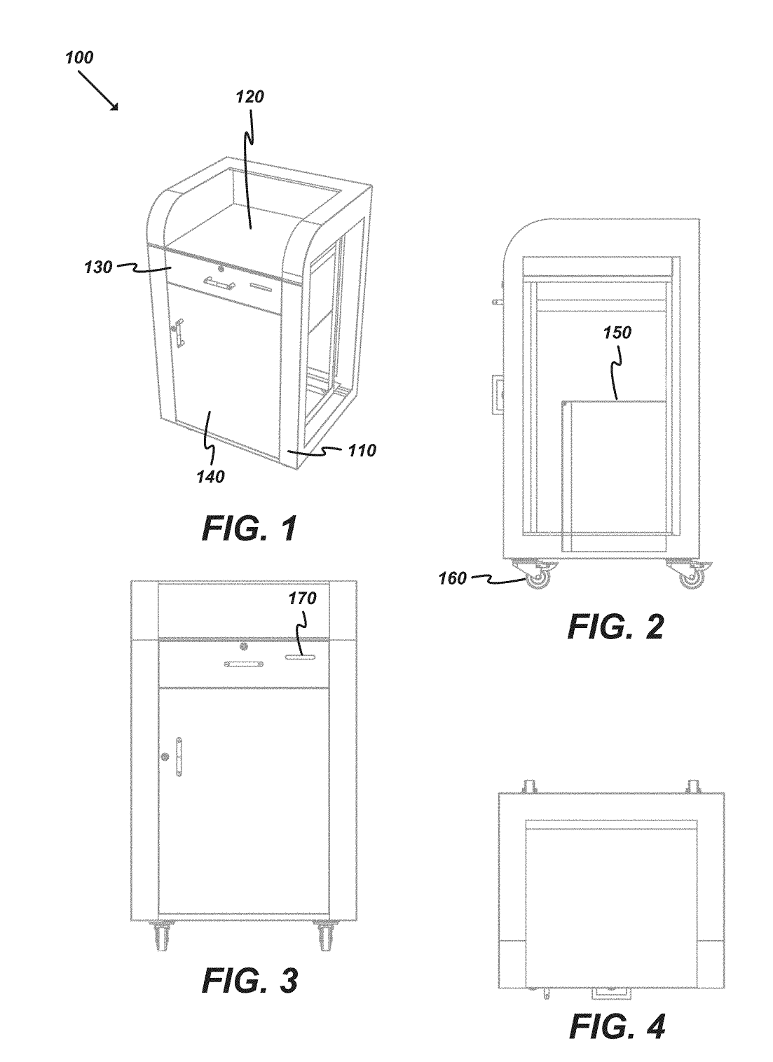

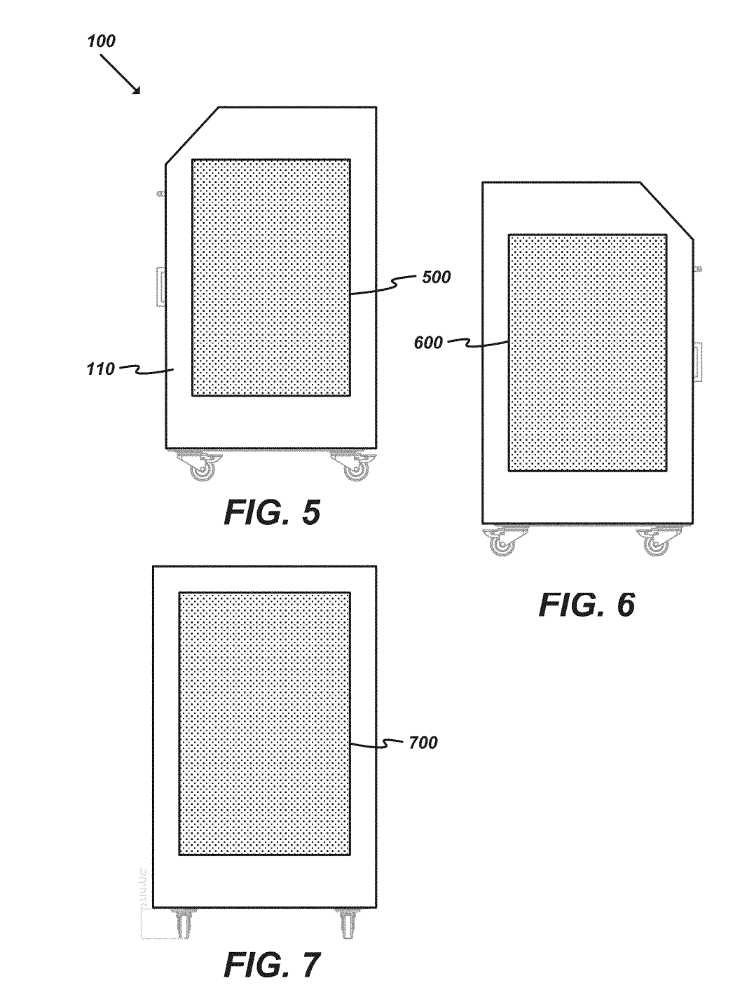

FIG. 1 illustrates a perspective view of a multimedia kiosk 100 according to an exemplary embodiment. FIG. 2 illustrates a side view of the multimedia kiosk 100. FIG. 3 illustrates a front view of the multimedia kiosk 100. FIG. 4 illustrates a top view of the multimedia kiosk 100. FIG. 5 illustrates a side view of the multimedia kiosk 100. FIG. 6 illustrates a side view of the multimedia kiosk 100. FIG. 7 illustrates a rear view of the multimedia kiosk 100.

As shown, the kiosk 100 may include a frame 110 and associated panels or exterior surfaces, a desktop area 120, one or more secure storage areas 130-140, various multimedia element housings 150, and mobile features (e.g., casters) 160. In this example, the top of the kiosk is rounded. However, different embodiments may have various different shapes or specific features.

Some embodiments may include one or more displays 500-700 (indicated by the dark fill areas). Such displays may provide video content, static content, digital signage, and/or other types of multimedia. The displays may be retained at openings in the exterior surface of the kiosk 100. Various attachment features (e.g., plates, bolts, etc.) may be used to hold the displays 500-700 in place. In some embodiments the displays may be able to be tilted, rotated, and/or otherwise manipulated while coupled to the kiosk 100.

The frame 110 and associated panels or exterior surfaces may include various structural members (e.g., beams or other linear elements, curved features, etc.), connecting elements (e.g., screws, nuts and bolts, adhesives, welds, etc.), flat panels, ballasts, etc. that are collectively able to provide structural support and definition for the kiosk 100. In this example, the kiosk has an angular profile rather than the curved profile shown in FIG. 1-FIG. 4.

The desktop area 120 may be a substantially flat panel or surface that is able to server as a workspace, temporary storage, etc. In some embodiments, the desktop area (and/or other areas of the kiosk) may include user interface (UI) elements such as keyboards, keypads, touchscreens, displays, audio elements, buttons, mice, touchpads, etc. Alternatively, such features may be supported by the desktop 120 and/or otherwise coupled to the kiosk 100. The desktop may include various other features, as appropriate, such as connection ports (e.g., USB ports, HDMI ports, etc.), wireless charging areas, scanners, etc.

The one or more secure storage areas 130-140 may include various locks, hinges, doors or panels, sliding features, security features, etc. The storage areas may include various specialized storage features, such as hooks arranged in a grid on one or more flat panels for use as key storage at a valet station. Other storage areas may include, for instance, sets of drawers for use by individual devices being charged.

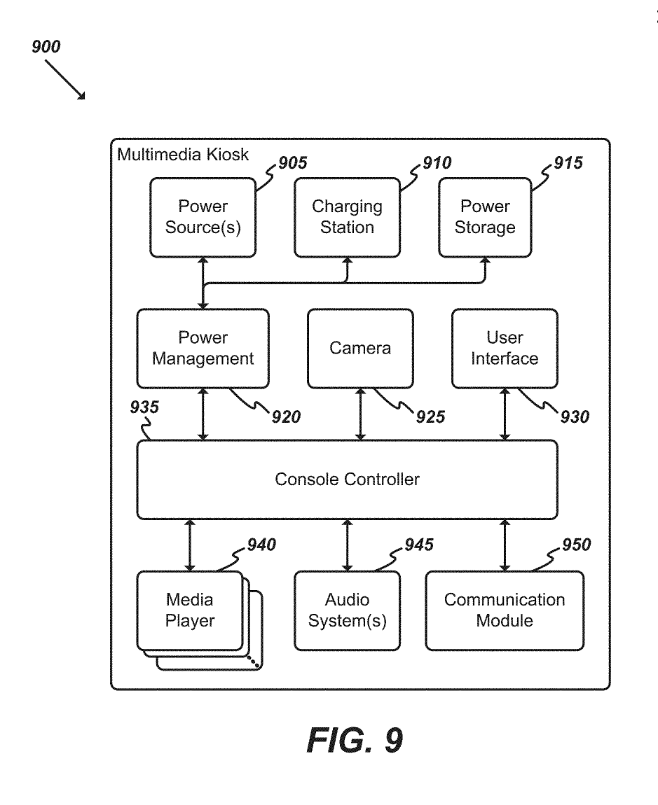

The various multimedia element housings 150 may include various structural elements, panels, etc. that may be able to house various electronic elements of the kiosk 100, such as power supplies, wireless communication elements, display drivers, audio drivers, etc. Such elements may include the various hardware elements described in more detail in reference to FIG. 9 below.

The mobile features (e.g., casters) 160 may include wheels, locking features, etc. that may allow the kiosk 100 to be moved along a surface and/or held in place once a desired position is achieved.

Each display 500-700 may be an electronic device that is able to provide graphics, video, and/or other multimedia to viewers. In these examples, the displays have a portrait orientation.

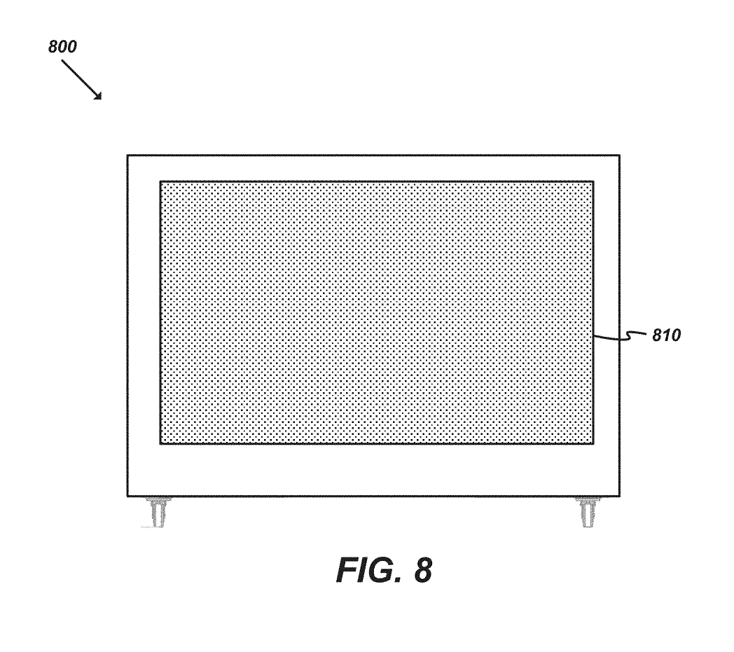

FIG. 8 illustrates a rear view of an alternative multimedia kiosk 800 of some embodiments. In this example, the display 810 has a landscape orientation. The kiosk may also include displays such as display 500 and display 600.

Different embodiments may include different numbers of displays and/or different arrangements of displays. For instance, for each display 500, 600, 700, and 810 described above, some embodiments may include multiple displays at each location (e.g., two landscape displays in place of one portrait display or two portrait displays in place of one landscape display). As another example, the displays may be sized differently such that only a portion of each area is used as a display area (the remaining area may be covered by exterior panels or other appropriate features) or some of the displays may be omitted entirely (e.g., some embodiments may include only a “front” display such as display 700 or 810). In some embodiments, the displays may be touchscreen displays that enable various user interactions with the kiosk 100 or 800.

Various other features may be included in some embodiments. For instance, some embodiments may include multiple speakers or other audio output features (e.g., a subwoofer port). As another example, some embodiments may include lights, umbrellas or other shade features, communication features (e.g., a telephone type handset, a microphone and speaker, etc.). Such features may be embedded into various locations of the kiosks, as appropriate (e.g., speaker outputs may be included at various locations along the outer panels of the kiosk, lights may be coupled to the frame members, etc.). Such features may be selectively attached to the kiosk (e.g., some embodiments may include a receptacle for an umbrella pole, a connector for attachment to an external multimedia system, etc.).

### II Hardware Architecture

FIG. 9 illustrates a schematic block diagram of a hardware architecture 900 of a multimedia kiosk 100. As shown, the console 900 may include one or more power sources 905, a charging station 910, power storage 915, a power management module 920, a camera 925, a user interface module 930, a console controller 935, one or more media players 940, one or more audio systems 945, and a communication module 950.

The one or more power sources 905 may include solar power sources, cable connectors, etc. In some embodiments, the kiosk 900 may be coupled to the power source(s) 905 during a charging phase and decoupled during a use phase (e.g., the kiosk 900 may be plugged in to an electrical outlet to charge and detached from the outlet when in use).

The charging station 910 may provide various connectors (e.g., USB ports), wireless charging areas or transmitters, and/or other appropriate elements that may be used to charge various devices. As described above, the charging station may be associated with a number of storage areas, such as drawers, that may be sized appropriately for charging various devices (e.g., smartphones, tablets, etc.) while also securely storing each device. In some embodiments, each such storage area may include a locking element and/or other security features (e.g., motion sensors). Some embodiments may capture data from and/or send promotions to devices stored by the kiosk 900.

The power storage 915 may include one or more rechargeable batteries (e.g., lithium ion batteries, absorbed glass mat (AGM) batteries, etc.) or other appropriate elements that may be able to store power for use by the kiosk 900.

The power management module 920 may include various elements such as inverters, transformers, etc. that may be able to control the power provided by the various sources 905 (and/or to control provision to the sources, such as when charging an internal rechargeable battery).

The camera 925 and/or other sensors (e.g., temperature or other weather conditions, position sensors such as gyroscopes, accelerometers, global positioning systems (GPS), etc.), or input devices may be used for security and/or surveillance. For instance, a camera may be used to capture images of the surrounding area at regular intervals or continuously (i.e., video capture). Such captured image data may be analyzed by a facial recognition module (and/or other analysis tools) and compared to a database, previously captured data, etc. Such analysis may be used to identify various events (e.g., theft, unauthorized access, etc.) that may trigger various responses (e.g., activation of a visible and/or audible alarm, transmission of an alert message to an external device or system, storage of event data in a log, etc.).

The user interface module 930 may include various features that allow a user to interact with the kiosk 900 and may be used to at least partly control the presentation of multimedia content. Such features may include features such as light emitting diode (LEDs) or other indicator lights (e.g., status, power level etc.), buttons, keypads, switches, knobs, touchscreens, displays, audio features (e.g., microphones, speakers, etc.), etc. Some embodiments may allow a user to select from multiple languages and may include language translation software for providing content in the selected language.

The console controller 935 may be able to interact with the various other console elements and at least partly direct their operations. The console controller may include various electronic circuitry that are able to execute various instructions and/or implements various logical operations. The controller may be able to implement various features in combination with the other elements of kiosk 900. For instance, the controller 935 may receive data from the sensors 925, analyze the received data, and identify events.

The one or more media players 940 may be able to render or otherwise provide media content to various hardware resources of the kiosk 900 (e.g., displays, speakers, etc.). The media player may utilize a local storage (not shown) for media content. Such media content may include signage, graphic elements, video, etc. and/or combinations of such media.

The one or more audio systems 945 may include various electronic components, such as amplifiers, that may be able to provide audible media via speakers or other appropriate features of the kiosk 900. Some embodiments may include features such as public address (PA) systems. The audio systems 945 may include directional sound systems.

The communication module 950 may be able to communicate across various appropriate interfaces (e.g., wired connections, local network connections, distributed network connections, Bluetooth, WiFi, radio transmitters and/or receivers, etc.). In some embodiments, the communication module may receive multimedia content that is then provided to the media players 940 (or other appropriate resource, such as the controller 935) for presentation to viewers. The communication module 950 may be paired or otherwise communicatively coupled to a local device such as a smartphone or tablet.

Some embodiments may include various other elements such as hardware drivers or interfaces associated with lights, communication, alarms, etc.

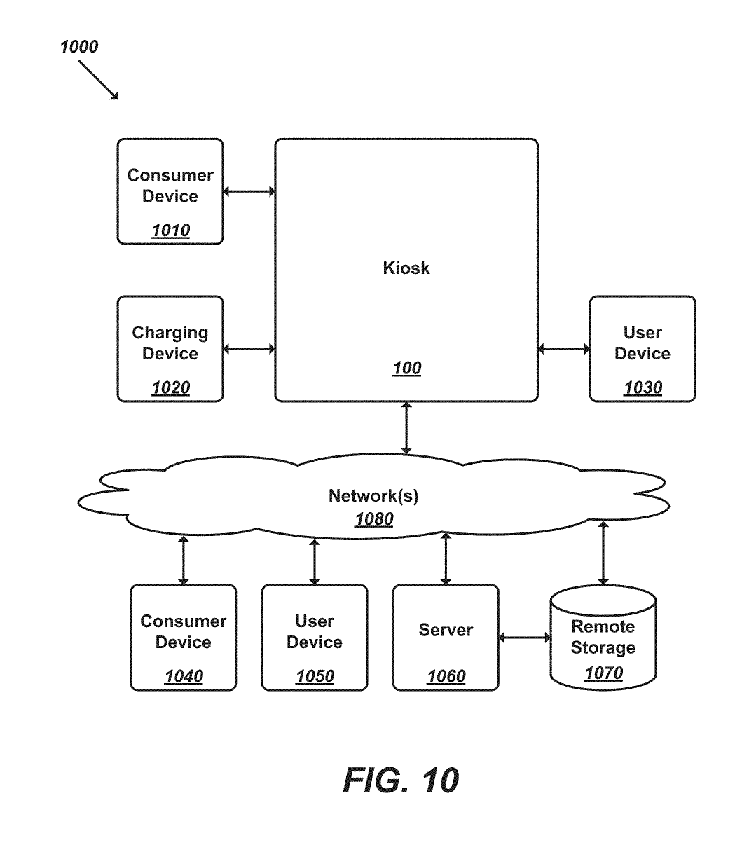

FIG. 10 illustrates a schematic block diagram of a system 1000 including a multimedia kiosk 100. As shown, the system 1000 may include kiosk 100, a local consumer device 1010, a charging device 1020, a local user device 1030, a remote consumer device 1040, a remote user device 1050, a server 1060, storage 1070, and network 1080. Although the system 1000 is shown as having one of each element, different embodiments may include multiple instantiations of any, some, or all of the system elements.

The local consumer device 1010 may be a device such as a smartphone or tablet that is able to communicate with the kiosk 100. Such interaction may be utilized to tabulate the number of viewers in the area of the kiosk, to select content based on user attributes, etc. In addition, some embodiments may allow user interaction via an application or web browser. Such interaction may include, for instance, a request for a valet service to retrieve a vehicle associated with the user.

The charging device 1020 may be a device such as a smartphone or tablet that is receiving charging power from the kiosk 100. The kiosk may, in addition to providing charging power to the charging device 1020, communicate with the device in order to retrieve user information or preferences, provide information to the device, and/or otherwise interact with the device.

The local user device 1030 may be associated with an administrator-user, such as an employee of a valet service. The local user device may communicate with the kiosk 100 across a wired or wireless connection. The local user device 1030 may be used to at least partly control various operations of the kiosk 100 (e.g., media selection, presentations settings such as brightness or volume, feature control such as lighting activation, security features such as alarms or video surveillance, etc.).

Some embodiments may provide Wi-Fi hotspot connectivity (and/or other appropriate resources) to the local user devices 1030 that are able to connect to such a feature.

The remote consumer device 1040 may be a device such as a smartphone, tablet, personal computer, wearable device, etc. that may be able to communicate with the kiosk 100 across one or more networks 1080. The remote consumer device 1040 may interact in similar ways to the local device 1010.

The remote user device 1050 may be similar to user device 1030 and may be used in a similar way across the network 1080 rather than via a local communication channel. Such a device may be associated with multiple kiosks 100. For instance, a super-user may select content for multiple kiosks 100 associated with a single venue, service provider, etc.

The server 1060 may be an electronic device that is able to execute instructions and/or otherwise process data. The server 1060 may be used to provide content to the kiosk 100 and/or otherwise control the operations of the kiosk. In some embodiments, the remote devices 1040-1050 may interact with the sever 1060 which may, in turn, interact with the kiosk 100.

The storage 1070 may store data and/or instructions related to the operation of the kiosk 100 and/or server 1060. Such data may include, for instance, multimedia content, user data, etc.

The network(s) 1080 may include various local and/or distributed networks (e.g., Ethernet, Wi-Fi, cellular networks, the Internet, etc.).

The system 1000 may allow the kiosk 100 to provide part of an out of home (OOH) network. In these cases, multimedia content (e.g., advertising content) provided by the kiosk may be retrieved or received from a resource such as server 1060.

One of ordinary skill in the art will recognize that system 1000 may be implemented in various different ways without departing from the scope of the disclosure. For instance, some elements may be omitted and/or additional elements may be included. As another example, the various elements may be arranged in different ways with different communication pathways.

### III. Methods of Operation

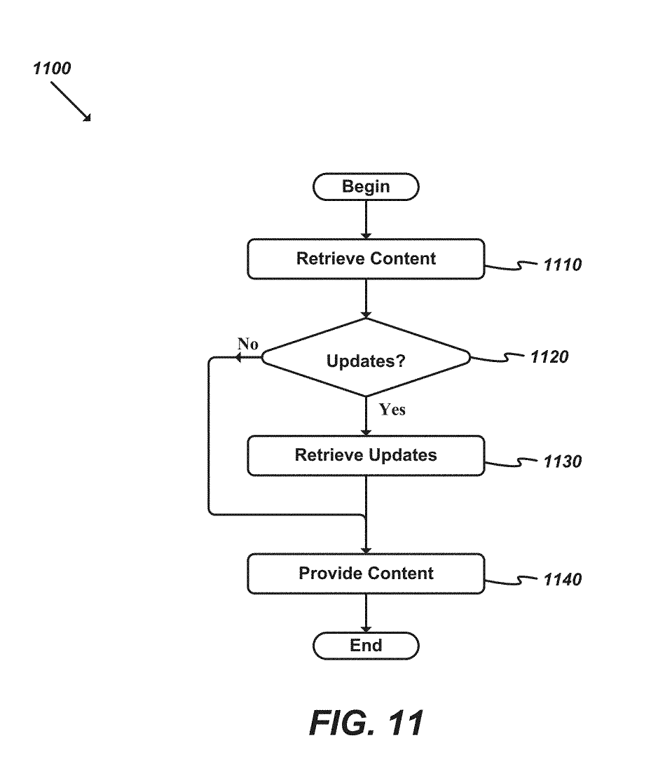

FIG. 11 illustrates a flow chart of an exemplary process 1100 that provides content via a multimedia kiosk of some embodiments. Such a process may begin, for instance, when a kiosk 100 is powered on.

As shown, the process 1100 may retrieve (at 1110) content. Such content may be retrieved from a local storage, external storage, etc. In some embodiments, the content may be received from another device. The content may include multimedia content as described above.

Next, the process may determine (at 1120) whether there are content updates (and/or other updates). Such a determination may be made in various appropriate ways, based on various appropriate criteria. For instance, an update message may be received at the kiosk 100 from some other component such as a user device 1030 or 1050 or a server 1060.

If the process determines (at 1120) that there are updates, the process may retrieve (at 1130) the updates. The updates may be retrieved from a resource such as server 1060, storage 1070, user device 1030 or 1050, and/or other appropriate resources.

After determining (at 1140) that no updates were available, or after retrieving (at 1130) the updates, the process may provide (at 1140) the content and then may end. The content may be provided through appropriate resources of the kiosk 100 (e.g., displays, speakers, etc.).

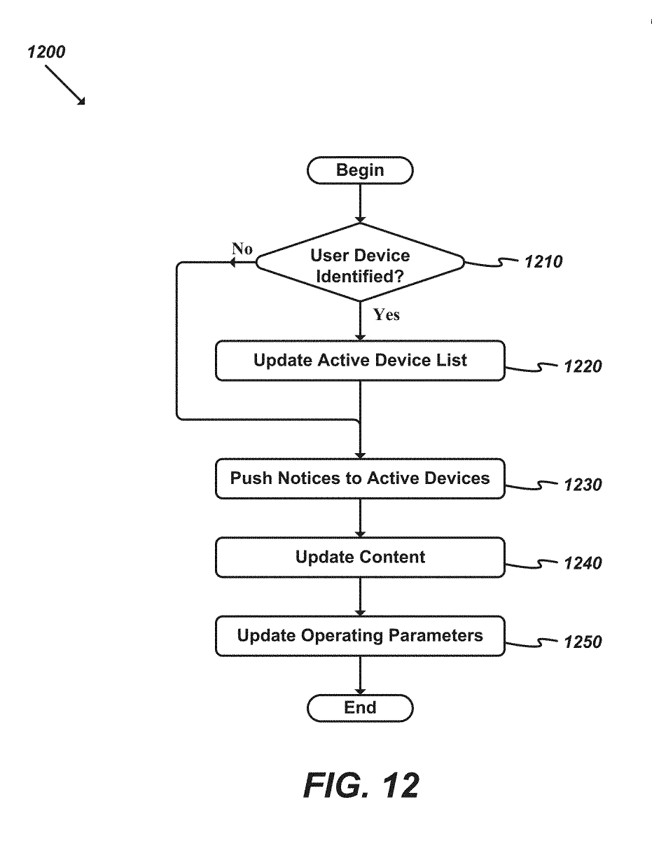

FIG. 12 illustrates a flow chart of an exemplary process 1200 that identifies proximate user devices and updates operation of a multimedia kiosk of some embodiments based on the identified devices. Such a process may begin, for instance, when a kiosk 100 is powered on.

The process 1200 may determine (at 1210) whether a user device associated with a viewer has been identified. Such a determination may be made in various appropriate ways based on various relevant criteria. For instance, some embodiments may transmit a beacon signal that is able to be received by external devices within a transmission range. The devices may respond to the beacon. Such responses may include, for instance, device information, user information, location information, etc.

If the process determines (at 1210) that a new user device has been identified, the process may update (at 1220) an active device list. Such a list may include all devices that have responded to the beacon within a defined time period.

After updating (at 1220) the list or determining (at 1210) that no new devices were identified, the process may push (at 1230) notifications to the devices in the active device list. Such notifications may include, for instance, marketing materials such as discounts, coupons, etc. Such notifications ay include information related to content provided by the kiosk, such as information related to currently playing media, information related to advertised establishments, goods, etc., and/or other appropriate information.

Next, the process may update (at 1240) the content being provided by the kiosk. Such an update may be based on a number of active users and/or attributes of the active users (e.g., demographic information, user preferences, etc.).

The process may then update (at 1250) current operating parameters and then may end. Such parameters may include, for instance, volume, brightness, lighting intensity, etc. For example, volume may be increased (or decreased) as the number of active users increases (or decreases).

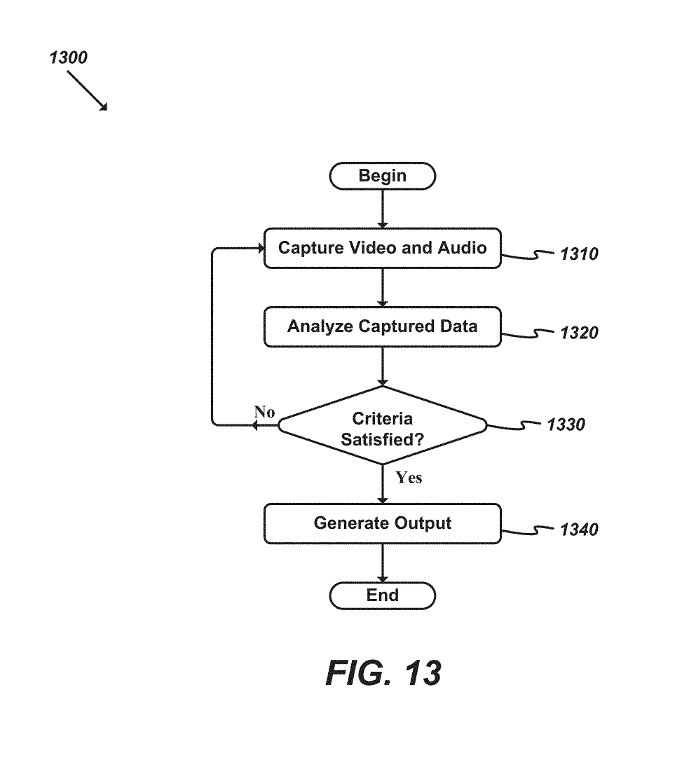

FIG. 13 illustrates a flow chart of an exemplary process 1300 that provides surveillance via a multimedia kiosk of some embodiments. Such a process may begin, for instance, when a kiosk 100 is powered on, when a surveillance feature is activated, and/or under other appropriate circumstances.

As shown, the process may capture (at 1310) video and/or audio information. In addition, other appropriate sensor information may be retrieved or captured. Such information may include, for instance, GPS data, accelerometer and/or gyroscope measurements, motion sensor output, etc.

Next, the process may analyze (at 1320) the captured data and then may determine (at 1330) whether any event criteria have been satisfied. Such a determination may be made in various appropriate ways, such as comparing the captured data to a set of thresholds.

If the process determines (at 1330) that the event criteria have been satisfied, the process may generate (at 1340) an output based on the event and then may end. If the process determines (at 1330) that the event criteria have not been satisfied, the process may repeat operations 1310-1330 until the process determines (at 1330) that the criteria have been satisfied.

Such events and responses or outputs may be defined in various appropriate ways. For instance, a user may set the kiosk 100 to be in a stationary position. When in such a stationary state, movement (as defined by accelerometer, GPS, or other appropriate position sensors) beyond a threshold distance may be associated with an alarm.

As another example, the sensors may be able to detect whether a drawer or door has been opened and the response may include an audible alarm or a message sent to an administrative user, security personnel, etc.

As still another example, the camera may capture image data including viewers' faces as they pass by the kiosk 100. Such data may be analyzed by facial recognition software and used to identify people for various purposes (e.g., security, matching of users to vehicles or valuables, etc.). A response to such an event may include a message being sent to a security service or indication of a drawer or other location identifier that may allow an administrative user to determine the location of the user's vehicle or valuables.

Processes such as processes 1100, 1200, and 1300 may be executed by a device such as kiosk 100. In some embodiments, the processes may be implemented by multiple devices (e.g., multiple devices from system 1000). In such cases, the multiple devices may execute complementary processes, as appropriate.

Processes 1100, 1200, and 1300 may be executed iteratively, at regular intervals, and/or based on some appropriate criteria (e.g., receipt of an update message or request, identification of viewers, etc.). The processes may be divided into multiple sub-processes and/or combined into larger macro processes.

### IV. Computer System

Many of the processes and modules described above may be implemented as software processes that are specified as one or more sets of instructions recorded on a non-transitory storage medium. When these instructions are executed by one or more computational element(s) (e.g., microprocessors, microcontrollers, digital signal processors (DSPs), application-specific integrated circuits (ASICs), field programmable gate arrays (FPGAs), etc.) the instructions cause the computational element(s) to perform actions specified in the instructions.

In some embodiments, various processes and modules described above may be implemented completely using electronic circuitry that may include various sets of devices or elements (e.g., sensors, logic gates, analog to digital converters, digital to analog converters, comparators, etc.). Such circuitry may be able to perform functions and/or features that may be associated with various software elements described throughout.

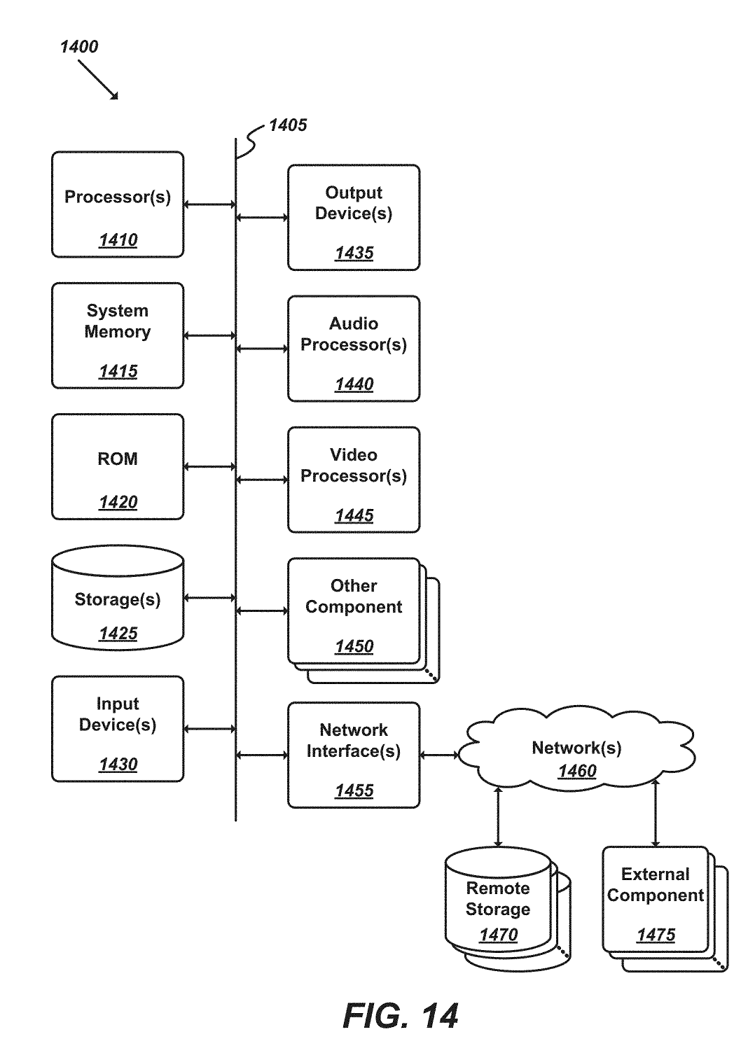

FIG. 14 illustrates a schematic block diagram of an exemplary computer system 1400 used to implement some embodiments. For example, the systems and devices described above in reference to FIG. 9 and FIG. 10 may be at least partially implemented using computer system 1400. As another example, the processes described in reference to FIG. 11, FIG. 12, and FIG. 13 may be at least partially implemented using sets of instructions that are executed using computer system 1400.

Computer system 1400 may be implemented using various appropriate devices. For instance, the computer system may be implemented using one or more personal computers (PCs), servers, mobile devices (e.g., a smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

As shown, computer system 1400 may include at least one communication bus 1405, one or more processors 1410, a system memory 1415, a read-only memory (ROM) 1420, permanent storage devices 1425, input devices 1430, output devices 1435, audio processors 1440, video processors 1445, various other components 1450, and one or more network interfaces 1455.

Bus 1405 represents all communication pathways among the elements of computer system 1400. Such pathways may include wired, wireless, optical, and/or other appropriate communication pathways. For example, input devices 1430 and/or output devices 1435 may be coupled to the system 1400 using a wireless connection protocol or system.

The processor 1410 may, in order to execute the processes of some embodiments, retrieve instructions to execute and/or data to process from components such as system memory 1415, ROM 1420, and permanent storage device 1425. Such instructions and data may be passed over bus 1405.

System memory 1415 may be a volatile read-and-write memory, such as a random access memory (RAM). The system memory may store some of the instructions and data that the processor uses at runtime. The sets of instructions and/or data used to implement some embodiments may be stored in the system memory 1415, the permanent storage device 1425, and/or the read-only memory 1420. ROM 1420 may store static data and instructions that may be used by processor 1410 and/or other elements of the computer system.

Permanent storage device 1425 may be a read-and-write memory device. The permanent storage device may be a non-volatile memory unit that stores instructions and data even when computer system 1400 is off or unpowered. Computer system 1400 may use a removable storage device and/or a remote storage device as the permanent storage device.

Input devices 1430 may enable a user to communicate information to the computer system and/or manipulate various operations of the system. The input devices may include keyboards, cursor control devices, audio input devices and/or video input devices. Output devices 1435 may include printers, displays, audio devices, etc. Some or all of the input and/or output devices may be wirelessly or optically connected to the computer system 1400.

Audio processor 1440 may process and/or generate audio data and/or instructions. The audio processor may be able to receive audio data from an input device 1430 such as a microphone. The audio processor 1440 may be able to provide audio data to output devices 1440 such as a set of speakers. The audio data may include digital information and/or analog signals. The audio processor 1440 may be able to analyze and/or otherwise evaluate audio data (e.g., by determining qualities such as signal to noise ratio, dynamic range, etc.). In addition, the audio processor may perform various audio processing functions (e.g., equalization, compression, etc.).

The video processor 1445 (or graphics processing unit) may process and/or generate video data and/or instructions. The video processor may be able to receive video data from an input device 1430 such as a camera. The video processor 1445 may be able to provide video data to an output device 1440 such as a display. The video data may include digital information and/or analog signals. The video processor 1445 may be able to analyze and/or otherwise evaluate video data (e.g., by determining qualities such as resolution, frame rate, etc.). In addition, the video processor may perform various video processing functions (e.g., contrast adjustment or normalization, color adjustment, etc.). Furthermore, the video processor may be able to render graphic elements and/or video.

Other components 1450 may perform various other functions including providing storage, interfacing with external systems or components, etc.

Finally, as shown in FIG. 14, computer system 1400 may include one or more network interfaces 1455 that are able to connect to one or more networks 1460. For example, computer system 1400 may be coupled to a web server on the Internet such that a web browser executing on computer system 1400 may interact with the web server as a user interacts with an interface that operates in the web browser. Computer system 1400 may be able to access one or more remote storages 1470 and one or more external components 1475 through the network interface 1455 and network 1460. The network interface(s) 1455 may include one or more application programming interfaces (APIs) that may allow the computer system 1400 to access remote systems and/or storages and also may allow remote systems and/or storages to access computer system 1400 (or elements thereof).

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 1400 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

The foregoing relates to illustrative details of exemplary embodiments and modifications may be made without departing from the scope of the disclosure as defined by the following claims.

I claim:

1. A multimedia kiosk comprising:
at least one power storage element;
a media player; and
at least one multimedia presentation element.

2. The multimedia kiosk of claim 1, wherein the at least one multimedia presentation element comprises a display and the media player renders multimedia content for provision to the at least one multimedia presentation element.

3. The multimedia kiosk of claim 1 further comprising at least one audio output element.

4. The multimedia kiosk of claim 1 further comprising at least one wireless communication module.

5. The multimedia kiosk of claim 1 further comprising at least one camera.

6. The multimedia kiosk of claim 1 further comprising at least one user device charging element.

7. The multimedia kiosk of claim 1 further comprising a desktop having at least one user interface feature.

8. A mobile interactive service podium comprising:
a frame;
a set of displays coupled to the frame;
a desktop coupled to the frame;
a storage cabinet coupled to the frame; and
a wireless communication module coupled to the frame.

9. The mobile interactive service podium of claim 8, wherein the frame comprises a service side and three exterior faces, each exterior face including at least one display.

10. The mobile interactive service podium of claim 9, wherein each display has a portrait orientation.

11. The mobile interactive service podium of claim 9, wherein a first display has a portrait orientation, a second display has a portrait orientation, and a third display has a landscape orientation.

12. The mobile interactive service podium of claim 8, wherein the storage cabinet comprises at least one charging station.

13. The mobile interactive service podium of claim 8 further comprising a surveillance system including at least one camera.

14. The mobile interactive service podium of claim 8, wherein the desktop comprises a user interface.

15. A method of providing multimedia content via a mobile kiosk, the method comprising:
retrieving multimedia content from a storage;
rendering the multimedia content at a media player; and
providing the rendered content to at least one display.

16. The method of claim 15 further comprising:
transmitting a beacon signal;
receiving a response from at least one user device; and
retrieving updated multimedia content from the storage.

17. The method of claim 15 further comprising:
retrieving a set of sensor measurements;
comparing the retrieved measurements to at least one threshold;
identifying an event if at least one measurement exceeds the at least one threshold; and
generating a response to the identified event.

18. The method of claim 15 further comprising:
establishing a network connection to a remote server;
receiving updated content from the server; and
rendering and providing the updated content.

19. The method of claim 18 further comprising:
establishing a communication channel with at least one user device; and
providing network connectivity to the at least one user device.

20. The method of claim 15, wherein the at least one display comprises three displays coupled to three exterior faces the mobile kiosk.
